(19) United States
(12) Patent Application Publication
(10) Pub. No.: US 2007/0252514 A1
(43) Pub. Date: Nov. 1, 2007

(54) Color organic light emmitting diode display

(75) Inventors: Chien-Chung Kuo, Taichung County (TW); Wei-Shan Ma, Taichung County (TW)

Correspondence Address: BACON & THOMAS, PLLC, 625 SLATERS LANE, FOURTH FLOOR, ALEXANDRIA, VA, 22314, US

(73) Assignee: Wintek Corporation, TAICHUNG (TW)

(21) Appl. No.: 11/411,945

(22) Filed: Apr. 27, 2006

(51) Int. Cl. H01J 1/62; H01J 63/04

(52) U.S. Cl. 313/504

(57) ABSTRACT

A simple and inexpensive structure of color organic light emitting diode display includes a transparent substrate, a color filter layer, a first electrode layer, an organic layer and a second electrode layer arranged orderly one by one. The color filter layer, which is disposed between the substrate and the first electrode layer, has a plurality of conductive first line members respectively electrically connected to the electrodes of the first electrode layer for use as auxiliary electrodes to reduce resistance of the circuit layout while maintaining aperture ratio of the pixel.

### BACKGROUND OF THE INVENTION

1. Field of the Invention

The present invention relates to a color display, and more particularly, to a color organic light emitting diode display.

2. Description of the Related Art

Basically, there are three conventional techniques to achieve a color organic light emitting diode display, i.e., side-by-side separate RGB emitting subpixels, color change medium (CCM) and white organic light emitting diode (OLED) integrated color filter technique. Among these three techniques, white OLED integrated color filter technique, which applies an organic layer for generating white light with a color filter, is the mostly popularly accepted technique for the advantages of easy manufacturing and high yield rate.

FIG. 4 shows a color organic light emitting diode display 3 made according to the white OLED integrated color filter technique. The color organic light emitting diode display 3 comprises from the bottom toward the top thereof a substrate 80, a color filter layer 81, an overcoat layer 82, a plurality of first electrodes 83, a plurality of insulators 84 arranged in parallel between the first electrodes 83, a plurality of metal conductive members 85 respectively disposed corresponding to the upper fringe of the first electrodes 83, an organic layer 86 capable of generating white light, and a plurality of second electrodes 87 arranged perpendicularly relative to the first electrodes 83. The color filter layer 81 is comprised of a plurality of partition films 81a that are intersected with one another thereby forming a black matrix (BM) that can block light and has a plurality of predetermination spaces, and a plurality of color films 81b respectively formed in the predetermination spaces. These color films 81b are made of photoresists of red (R), green (G) or blue (B) colors respectively. Each color film 81b forms a sub-pixel of the display 3. A pixel zone comprises three different color films 81b, R, G and B. By means of driving the organic layer 86 to emit white light through the color filter layer 81, the display 3 provides an image of full color.

Since the first electrodes 83 need to be transparent conductive films that have a high resistance, they are not suitable for use directly as a conductive circuit for driving the above-mentioned display 3. Therefore, the aforesaid metal conductive members 85 electrically respectively connected to the first electrodes 83 are used as auxiliary electrodes. When a data signal is simultaneously transferred to the first electrode 83 through a corresponding metal conductive member 85, and a scan signal to is transferred to the second electrode 87, predetermination spaces of the organic layer 86 will emit white light that passes through the corresponding color film 81b to further produce a color image. Metal materials and many other conductive compound materials (such as silver, silver alloy, aluminum, aluminum alloy, and etc.) may be selectively used for making the aforesaid auxiliary electrodes. Auxiliary electrodes made of metal materials have low resistance, however they are opaque. Therefore, the metal conductive members 85 block a part of the white light that emits from the organic layer 86 to the color films 81b. Consequently, the effective light emitting area is reduced and the aperture ratio of pixel is decreased. When reducing the area of the auxiliary electrodes in order to maintain the aperture ratio of pixel, the conductivity will be relatively lowered, resulting in a relative increase of the resistance of the circuit layout. When increasing the thickness of the auxiliary electrodes in order to improve the problems of aperture ratio and impedance, the manufacturing process will be complicated, resulting in a high manufacturing cost.

### SUMMARY OF THE INVENTION

The present invention has been accomplished under the circumstances in view. It is therefore the main object of the present invention to provide a color organic light emitting diode display, which provides a full-color image output, eliminates the impedance problem of circuit layout, and increases the aperture ratio.

It is another object of the present invention to provide a color organic light emitting diode display, which reduces the design of auxiliary electrodes, thereby shortening the manufacturing process, improving the yield rate and lowering the manufacturing cost.

To achieve these objects of the present invention, the color organic light emitting diode display comprises a transparent substrate, a color filter layer formed on the transparent substrate, and a first electrode layer formed above the color filter layer. The color filter layer has a plurality of first line members, a plurality of second line members and a filter matrix. The first line members are electrically conductive and light-blocking. The second line members are respectively arranged between each two adjacent first line members. The filter matrix has a plurality of color films arranged in spaces surrounded by the first line members and the second line members. The first electrode layer comprises a plurality of transparent electrodes isolated from one another and respectively electrically connected to the first line members. In a preferred embodiment of the present invention, the color organic light emitting diode display further comprises an organic layer arranged above the first electrode layer for emitting white light, and a second electrode layer arranged above the organic layer and provided with a plurality of electrodes extending along a direction perpendicular to the extending direction of the electrodes of the first electrode layer.

### BRIEF DESCRIPTION OF THE DRAWINGS

FIG. 1 is a schematic exploded view of a color organic light emitting diode display according to a first preferred embodiment of the present invention.

FIG. 2 is a sectional assembly view of the color organic light emitting diode display according to the first preferred embodiment of the present invention.

FIG. 3 is a sectional assembly view of the color organic light emitting diode display according to a second preferred embodiment of the present invention.

FIG. 4 is a schematic sectional view of a color organic light emitting diode display according to the prior art.

### DETAILED DESCRIPTION OF THE INVENTION

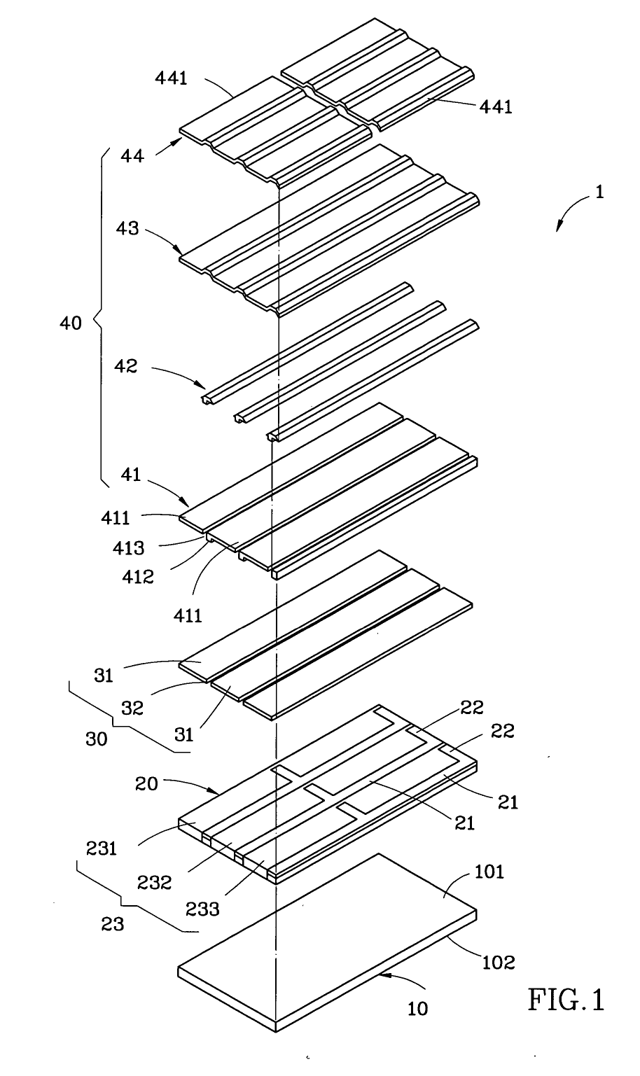

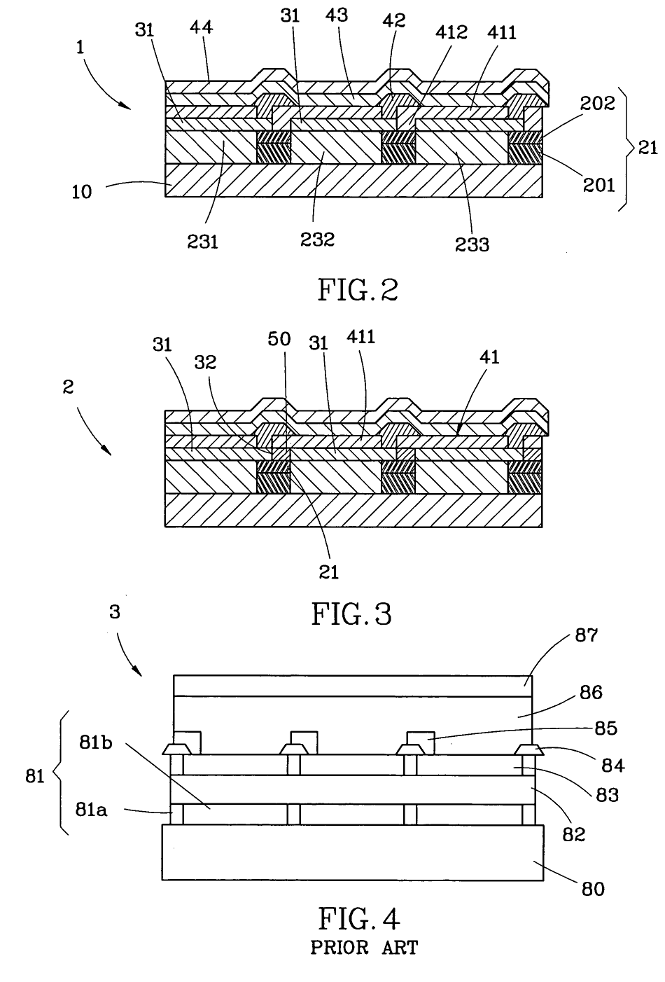

Referring to FIGS. 1 and 2, a color organic light emitting diode display 1 in accordance with the first preferred embodiment of the present invention is shown comprising a transparent substrate 10, a color filter layer 20, an insulative layer 30, and an OLED (organic light emitting diode) 40.

The transparent substrate 10 has a top surface 101 and a bottom surface 102. Because the substrate 10 is set at the bottom side of the color organic light emitting diode display 1 and optical signal passes out of the bottom surface 102 of the transparent substrate 10, the color organic light emitting diode display 1 in the present preferred embodiment is a bottom-emitting type display. Because the substrate 10 must have the characteristic of fully transparent for free passing of optical signal, a transparent material is used for making the substrate 10. Further, the top surface 101 of the substrate 10 is well polished to prevent dispersion of light that may result in attenuation of light and other optical interference.

The color filter layer 20 is covered on the top surface 101 of the transparent substrate 10, comprising a plurality of first line members 21, a plurality of second line members 22, and a color filter matrix 23.

The fabrication of the first line members 21 and the second line members 22 are described hereinafter.

Because the color organic light emitting diode display 1 is a bottom-emitting type display, a light absorptive chrome oxide film is coated on the substrate 10 at first to prevent interference of reflective light upon radiation of external light source onto the bottom surface 102, and then a chrome is coated on the chrome oxide film for the advantage of good conductivity, and then using photolithography technology to form a pattern on the substrate 10 that contains the first line members 21 and second line members 22. The first line members 21 extend in longitudinal direction. The second line members 22 are respectively transversely arranged between each two adjacent first line members 21. The first line members 21 and the second line members 22 each have a laminated structure comprised of a compound layer 201 of chrome oxide and a metal layer 202 of chrome as shown in FIG. 2. The metal layer 202 has light-blocking and electrically conductive characteristics. Each second line member 22 has one end connecting one first line member 21 and the other end spaced from another first line member 21 at a distance. This arrangement prevents a short circuit between the first line members 21 by the second line members 22 upon input of electric drive signal. During fabrication of the first line members 21 and the second line members 22, the compound layer 201 may be eliminated while maintaining the metal layer 202 fabrication process. This method has the first line members 21 and the second line members 22 made of a single layer structure with good conductivity.

The filter matrix 23 is made as follows.

After formation of the first line members 21 and the second line members 22, red, green and blue photoresists are respectively orderly formed in the spaced surrounded by the first line members 21 and the second line members 23, thereby forming color films 231, 232, 233. These color films 231, 232, 233 form the color filter matrix 23. At this time, the fabrication of the color filter layer 20 is completed.

Because repeating a forming process several times makes the filter matrix 23 of the color filter layer 20, in order to have a flat interface for the attachment of the later OLED 40 the insulative layer 30 is used in the present embodiment to be covered on the topside of the color filter layer 20. The insulative layer 30 is formed on the color filter layer 20 from photosensitive acrylic resin and then processed the patterning process, thereby forming multiple strips of transparent insulative film 31 and a crevice 32 between each two strips of transparent insulative film 31. The strips of transparent insulative films 31 are arranged in parallel to the first line members 21 and respective covered on the color films 231, 232, 233, as shown in FIG. 2. These first crevices 32 correspond to the first line members 21, allowing exposure of the first line members 21 partially. These strips of transparent insulative film 31 allow the light of the OLED 40 to pass completely, protect the color films 231, 232, 233 against interference of high temperature during the posterior manufacturing procedures, and provide a good adhesion between the color filter layer 20 and the OLED 40.

The OLED 40 comprises a first electrode layer 41, a plurality of separation films 42, an organic layer 43, and a second electrode layer 44. The first electrode layer 41 is comprised of a plurality of transparent electrodes 411 and a plurality of extension ribs 412. The first electrode layer 41 is made by depositing a thin layer of ITO (INDIUM TIN OXIDE) on the top surface of the insulative layer 30 and then using photolithography technology to pattern the ITO film into multiple strips of transparent film, i.e., the aforesaid transparent electrodes 411. At this time, a second crevice 413 is formed between each two adjacent transparent electrodes 411, and a part of the ITO film that fills the first crevices 32 is maintained after photolithographic process and forms the aforesaid extension ribs 412. These extension ribs 412 each have one end respectively electrically connected to the first line members 21, i.e., the electrodes 411 and the first line members 21 are directly connected together so that the first line members 21 are used as signal lines for driving the color organic light emitting diode display 1.

The separation films 42 are strip members formed by coating photosensitive polyimide on the first electrode layer 41 and patterning the photosensitive polyimide coating into strips that fill up the second crevices 413 and arranged in parallel to the first line members 21, as shown in FIG. 2. Each separation film 42 covers the border areas of the two adjacent transparent electrodes 411 to isolate the transverse electric field effect between two adjacent transparent electrodes 411 so as to prevent optical interference due to interference of margin electric field effect upon light emission of the OLED 40.

Covering a layer of organic light emitting diode material on the first electrode layer 41 and the separation films 42 forms the organic layer 43. Thereafter, a conductive material (for example, aluminum) is deposited on the organic layer 43 and patterned into strip-like electrodes 441. These electrodes 441 form the aforesaid second electrode layer 44. Further, these electrodes 441 are arranged at right angles relative to the transparent electrodes 411. The second electrode layer 44 works as signal line means for driving the color organic light emitting diode display 1.

Further, in addition to the strip-like structure that fills up the second crevices 413 and arranged in parallel to the first line members 21 when making the separation films 42, an additional grid-like insulation film may be formed corresponding to the second line members 22 and arranged at right angles relative to the strip-like structure for use isolation means to prevent electric connection between each two electrodes 441 of the second electrode layer 44, so as to reduce the transverse electric field effect between each two adjacent electrodes 441 and to improve the quality of the OLED 40.

According to the present invention, the light-blocking first line members 21 and the second line members 22 that separate the color films 231, 232, 233 are made electrically conductive, and the electrodes 411 of the first electrode layer 41 are directly and electrically connected to the first line members 21 for enabling the first line members 21 to work as auxiliary electrodes for the electrodes 411 of the first electrode layer 41. Therefore, the invention has a low resistance characteristic while maintaining the optimum aperture ratio, i.e., the invention eliminates the problem that high aperture ratio and low resistance cannot exist at the same time in the prior art designs. Further, the invention shortens the fabrication of the auxiliary electrodes, thereby improving the yield rate and lowering the manufacturing cost.

FIG. 3 shows a second preferred embodiment of the present invention. According to this embodiment, the color organic light emitting diode display 2 is substantially similar to the aforesaid first embodiment in structure with the exceptions outlined hereinafter.

After formation of the insulative films 31 and the first crevices 32 during fabrication of the color organic light emitting diode display 2, conductive ribs 50 are formed in the first crevices 32, keeping one end of each conductive rib 50 in contact with the first line members 21 respectively. Thereafter, the first electrode layer 41 is formed and the electrodes 411 of the first electrode layer 41 touch the other end of each of the conductive ribs 50 respectively. Thus, the first line members 21 and the electrodes 411 are electrically connected, and the first line members 21 work as auxiliary electrodes for the electrodes 411 of the first electrode layer 41. Therefore, this alternate form has the characteristic of low resistance while maintaining the aperture ratio.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A color organic light emitting diode display comprising:
a transparent substrate;
a color filter layer disposed on the transparent substrate, the color filter layer comprising a plurality of first line members, a plurality of second line members and a filter matrix, the first line members being electrically conductive and light-blocking, the second line members being respectively arranged between each two adjacent first line members, the filter matrix comprising a plurality of color films arranged in spaces surrounded by the first line members and the second line members;
a first electrode layer arranged above the color filter layer, the first electrode layer comprising a plurality of transparent electrodes isolated from one another and respectively electrically connected to the first line members;
an organic layer arranged above the first electrode layer for emitting white light; and
a second electrode layer disposed on the organic layer.

2. The color organic light emitting diode display as claimed in claim 1, further comprising an insulative layer disposed between the color filter layer and the first electrode layer, the insulative layer comprising a plurality of transparent insulative films and a plurality of first crevices between each two transparent insulative films; the transparent electrodes of the first electrode layer being respectively arranged on the insulative films and each having an extension rib respectively extending to the first crevices and respectively connected to the first line members.

3. The color organic light emitting diode display as claimed in claim 1, further comprising an insulative layer disposed between the color filter layer and the first electrode layer, and a plurality of conductive ribs, the insulation layer comprising a plurality of transparent insulative films and a plurality of second crevices respectively defined between each two adjacent transparent insulative films, the conductive ribs being respectively formed in the first crevices and each having a first end respectively connected to the first line members and a second end respectively connected to the transparent electrodes of the first electrode layer.

4. The color organic light emitting diode display as claimed in claim 2, wherein the insulative layer is made of photosensitive acrylic resin.

5. The color organic light emitting diode display as claimed in claim 3, wherein the insulative layer is made of photosensitive acrylic resin.

6. The color organic light emitting diode display as claimed in claim 1, wherein the first electrode layer further comprises a plurality of second crevices defined between each two adjacent transparent electrodes, and the color organic light emitting diode display further comprises a plurality of separation films respectively formed in the second crevices.

7. The color organic light emitting diode display as claimed in claim 1, wherein the first line members each comprise a metal layer for the connection of the transparent electrodes of the first electrode layer respectively.

8. The color organic light emitting diode display as claimed in claim 7, wherein the first line members each further comprise a compound layer supporting the respective metal layer.
